(19) United States
(12) Patent Application Publication
(10) Pub. No.: US 2002/0181035 A1
(43) Pub. Date: Dec. 5, 2002

(54) Method and system for combining multiple low power laser sources to achieve high efficiency, high power outputs using transmission holographic methodologies

(76) Inventor: John Donoghue, South Boston, MA (US)

Correspondence Address: McDermott, Will & Emery, 28 State Street, Boston, MA, 02109, US

(21) Appl. No.: 09/952,681

(22) Filed: Sep. 14, 2001

Related U.S. Application Data
(60) Provisional application No. 60/232,309, filed on Sep. 14, 2000.
(60) Provisional application No. 60/232,550, filed on Sep. 14, 2000.
(60) Provisional application No. 60/232,254, filed on Sep. 14, 2000.
(60) Provisional application No. 60/232,307, filed on Sep. 14, 2000.

(51) Int. Cl. G03H 1/10; H04J 14/02

(52) U.S. Cl. 359/10; 359/124

(57) ABSTRACT

The Holographic Beam Combiner, (HBC), is used to combine the output from many lasers into a single-aperture, diffraction-limited beam. The HBC is based on the storage of multiple holographic gratings in the same spatial location. By using a photopolymer material such as quinone-doped polymethyl methacrylate (PMMA) that uses a novel principle of “polymer with diffusion amplification” (PDA), it is possible to combine a large number (N) of diode lasers, with an output intensity and brightness 0.9 N times as much as those of the combined outputs of individual N lasers. The HBC will be a small, inexpensive to manufacture, and lightweight optical element.

The basic idea of the HBC is to construct multiple holograms onto a recording material, with each hologram using a reference beam incident at a different angle, but keeping the object beam at a fixed position. When illuminated by a single read beam at an angle matching one of the reference beams, a diffracted beam is produced in the fixed direction of the object beam. When multiple read beams, matching the multiple reference beams are used simultaneously, all the beams can be made to diffract in the same direction, under certain conditions that depend on the degree of mutual coherence between the input beams.

### CROSS REFERENCE TO RELATED APPLICATIONS

This application claims the benefit of priority from commonly owned U.S. Provisional Patent Application Serial No. 60/232,309, filed Sep. 14, 2000; U.S. Provisional Patent Application Serial No. 60/232,550 filed Sep. 14, 2000; U.S. Provisional Patent Application Serial No. 60/232,254 filed Sep. 14, 2000; and U.S. Provisional Patent Application Serial No. 60/277,529, filed Mar. 22, 2001.

### FIELD OF THE INVENTION

The present invention relates to a system for and method of combining the outputs of multiple laser beams, the system and method having a wide range of uses, including, but not limited to military and space applications such as high power, high brightness sources for medium and short range ladars, high energy laser based anti-missile defensive weapons, over-the-air optical communications and fiber based optical telecommunications.

### BACKGROUND OF THE INVENTION

Holography is a technique for recording and later reconstructing the amplitude and phase disturbution of a coherent wave distrubance. Generally, the technique utilized for producing a holographic element is accomplished by recording the pattern of interference between two optical beams or waves. Historically, holography was developed for displaying three dimentional images, with the very first development by the inventor, Dennis Gabor. The waves, one reflected from an imaged object, called the object wave, and a second that by-passes the imaged object, called the reference wave, are used to record the information in light sensitive recording medium, such as a holographic film or plate.

In this invention, we present techniques for combining laser beams using holography in thick substrates. Several alternative techniques exist for combining laser beams, however each has its limitations. It should be noted that the technique used for beam combining is reversable, by changing the direction of combined beams, thus combining and separation can be accomplished with the same optical devices. The three techniques that are most commonly used are:

Incoherent beam combining with beam-splitters With this approach, a conventional beam-splitter is used to combine beams. For cross-polarized beams, this process can combine only two lasers using polarizing beam splitters. Additionally, birefringence-induced depoloarization would cause the output to fluctuate. Finally, this approach cannot be cascaded since the combined beam is in general unpolarized. If a nonpolarized beam is used, the process is cascadable, but the coupling efficiency falls off rapidly with increased number of stages.

Coherent beam combining via phase locking—If the lasers are phase locked, in principal many can be combined coherently using a set of beam splitters with differing splitting ratios. In practice, this approach is very complicated and fragile, and is incompatible with combining inexpensive, independent diode lasers.

Thin grating based beam combining—In this approach, several beams can be combined by matching each of the dominant diffraction indices in a blazed grating. However, in order to prevent loss of coupling efficiency in the desired direction, the input lasers beams have to be apart in wavelength by at least 2 nm typically, thus limiting the number of lasers for a practical application. For example, in the case of an EDFA pump at 980 nm, the pump gain window is only 8 nm wide. As such, only 4 lasers can be combined, yielding a pump power of about 1 Watt. For some applications, EDFA powers of 10 Watts or more are required, thus this combining method is not a viable solution for these application.

### SUMMARY OF THE INVENTION

In acccordance with one aspect of the invention, a method comprises: directing a plurality of beams of radiation from different angles to a single-aperture, so as to combine the beams and so as to create a single diffraction-limited beam using holographic methodologies such that each of the beams can be subsequently separated from the single diffraction-limited beam. The beams of radiation can each be coherent or incoherent. In one example the respective wavelengths are correspondingly spaced no more than 0.03 nm. In another example the respective wavelengths that are correspondingly spaced no more than 0.01nm. The combined beam can be recorded in a holographic recording material, in which event they can be separately capable of being read using holographic methodologies.

In accordance with another aspect of the invention a method is provided for writing a hologram to a holographic medium at one wavelength so that it can be selectively read at a different wavelengths, wherein the wavelengths are spaced apart over a predetermined range with adjacent wavelengths being separated within 0.03 nm of each other. In one example, the predetermined range is at least three hundred nm.

In accordance with another aspect of the invention, a method comprises: generating a plurality of laser beams at multiple frequencies; and providing a stable, all optic feedback control so as to lock the frequencies of the plurality of laser beams.

In accordacne with yet another aspect of the invention, a method comprises: cascading two or more stages of laser sources so as to generate laser beams that are combined using holographic methodologies so as to reach at least ten watts of power output.

In accordance with still another aspect of the invention, a method comprises: cascading two or more stages of laser sources so as to generate laser beams that are combined using holographic methodologies so as to reach at least one hundred watts of power output.

In accordance with yet another aspect of the invention, a method comprises: cascading two or more stages of laser sources so as to generate laser beams that are combined using holographic methodologies so as to reach at least one thousand watts of power output.

In accordance with still another aspect of the invention, a method of selectively separating a plurality of combined mutually incoherent laser beams, varying in frequency, from a combined source.

In accordance with yet another aspect of the invention, a method of writing transmission holograms so that a single holographic substrate may be used to combine and separate laser beams in two directions, offset by 180°.

In accordance with still another aspect of the invention, a system comprises: a device for defining a single-aperture; and a plurality of sources of beams of radiation positioned so that the beams of radiation are directed from different angles to the single-aperture so as to combine the beams and so as to create a single diffraction-limited beam using holographic methodologies such that each of the beams can be subsequently separated from the single diffraction-limited beam. The sources of beams of radiation can each be coherent or incoherent. The sources of beams of radiation can be generated at respective wavelengths that are correspondingly spaced no more than 0.03 nm in one example, and 0.01 nm in another example. In another embodiment the system further including a holographic medium, wherein the combined beam is recorded in a holographic recording material. The beams of radiation can be generated at respective wavelengths that are separately capable of being read using holographic methodologies and are correspondingly spaced no more than 0.01 nm and in one example, and 0.03 nm in another example. In one embodiment the predetermined range is at least three hundred nm.

In accordance with yet another aspect of the invention, a system comprises: means for generating a plurality of laser beams at multiple frequencies; and a stable, all optic feedback control so as to lock the frequencies of the plurality of laser beams.

In accordance with still another aspect of the present invention, a system comprises: a plurality of stages of laser sources cascaded together so as to generate laser beams that are combined using holographic methodologies so as to reach at least ten watts of power output.

In accordance with yet another aspect of the present invention, a system comprises: a plurality of stages of laser sources cascaded together so as to generate laser beams that are combined using holographic methodologies so as to reach at least one hundred watts of power output.

In accordance with still another aspect of the present invention, a system comprises: a plurality of stages of laser sources cascaded together so as to generate laser beams that are combined using holographic methodologies so as to reach at least one thousand watts of power output.

In accordance with yet another aspect of the present invention, a system comprisies: a reader for selectively separating a plurality of combined mutually incoherent laser beams previously combined using holographic methodologies and varying in frequency from a combined source.

In accordance with still another aspect of the present invention, a system is described for writing transmission holograms so that a single holographic substrate may be used to combine and separate laser beams in two directions, offset by 180°.

In accordance with yet another aspect of the present invention, a method of constructing a plurality of holograms onto a medium, comprisies: creating the plurality of holograms onto the medium using a common object beam and a corresponding plurality of reference beams directed to a single aperture, the reference beams being incident on the single aperture at respective and different angles of incidence while keeping the object beam fixed and the same for all of the reference beams so that when illuminated by a single read beam at an angle matching one of the reference beams, a diffracted beam is produced in the fixed direction of the object beam.

In accordance with still another aspect of the invention, a method is provided of reading any one of a plurality of holograms created onto a medium using a common object beam and a corresponding plurality of reference beams directed to a single aperture, the reference beams being incident on the single aperture at respective and different angles of incidence while keeping the object beam fixed and the same for all of the reference beams, comprising: illuminating the medium with at a single read beam at an angle matching one of the reference beams so that a diffracted beam is produced in the fixed direction of the object beam.

In accordance with yet another aspect of the invention, a method is provided of reading any one of a plurality of holograms created onto a medium using a common object beam and a corresponding plurality of reference beams directed to a single aperture, the reference beams being incident on the single aperture at respective and different angles of incidence while keeping the object beam fixed and the same for all of the reference beams, comprising: simultaneously illuminating the medium with a plurality of read beams, correspondingly matching the the angles of incidence of at least some of the reference beams, so that a corresponding number of beams can be made to diffract in the same direction.

In accordance with still another object of the present invention, a system is provided for reading any one of a plurality of holograms created onto a medium using a common object beam and a corresponding plurality of reference beams directed to a single aperture, the reference beams being incident on the single aperture at respective and different angles of incidence while keeping the object beam fixed and the same for all of the reference beams, comprising: a medium; a source of a single read beam for illuminating the medium at an angle matching one of the reference beams so that a diffracted beam is produced in the fixed direction of the object beam.

In accordance with yet another object of the present invention, a system is provided for reading any one of a plurality of holograms created onto a medium using a common object beam and a corresponding plurality of reference beams directed to a single aperture, the reference beams being incident on the single aperture at respective and different angles of incidence while keeping the object beam fixed and the same for all of the reference beams, comprising: a plurality of sources of reference beams positioned so as to simultaneously illuminate the medium with a plurality of read beams, correspondingly matching the the angles of incidence of at least some of the reference beams, so that a corresponding number of beams can be made to diffract in the same direction.

In accordance with still another aspect of the present invention, a method is provided of writing a plurality of holograms onto a medium using the following equations:

$$[ {θ}_{W 1} = {Sin}^{- 1} [ {n}_{W} \cdot Sin \{ {Sin}^{- 1} [ \frac{{n}_{R}}{{n}_{W}} \cdot \frac{{λ}_{W}}{{λ}_{R}} \cdot Sin ( {\tilde{θ}}_{S} + \tilde{δ} / 2 ) ] - \tilde{δ} / 2 \} ] ] \\ [ {θ}_{W 2} = {Sin}^{- 1} [ {n}_{W} \cdot Sin \{ {Sin}^{- 1} [ \frac{{n}_{R}}{{n}_{W}} \cdot \frac{{λ}_{W}}{{λ}_{R}} \cdot Sin ( {\tilde{θ}}_{S} + \tilde{δ} / 2 ) ] + \tilde{δ} / 2 \} ] ] \\ [ {\tilde{θ}}_{S} = {Sin}^{- 1} ( \frac{Sin {θ}_{S}}{{n}_{R}} ) ] \\ [ \tilde{δ} = {Sin}^{- 1} ( \frac{Sin ( {θ}_{S} + δ )}{{n}_{R}} ) - {Sin}^{- 1} ( \frac{Sin {θ}_{S}}{{n}_{R}} ) ]$$

wherein δ≡(Re ad Angle at λ_{W})−(Re ad Angle at a predetermined wave length λₒ)

n_{W}≡index at the writing wavelength

n_{R}≡index at the reading wavelength

λ_{W}≡the writing wavelength

λ_{R}≡the reading wavelength.

The method comprises the steps of:

a. Choose a fixed value for θ_{S};

b. Choose a fixed value for λ_{W};

c. Determine the symmetric pair of writing angles, θ_{W1} and θ_{W2}, which correspond to the case of λ_{R} and δ=0

d. Choose a new value of δ and a new value of λ_{R}, which yield a new pair of writing angles; and

e. Repeat step d for every new pair of writing angles necessary.

### BRIEF DESCRIPTION OF THE DRAWINGS

FIG. 1 is a schematic illustration of a holographic beam combiner diffracting incoming laser beams at different angles, to a single, high power, high brightness output beam.

FIG. 2 is a schematic illustration of the geometry for writing two holograms at 532 nm. The angles of the writing beams are chosen to ensure that when these holograms are read by two lasers each at around 980 nm, the output beams will overlap.

FIG. 3 is a schematic illustration of the geometry for reading the two holograms, the first one at 980 nm and the second one at a wavelength slightly longer than 980 nm.

FIG. 4 is a table of calculated writing angles for producing the beam combiner in accordance with one preferred embodiment of the present invention, where the writing wavelength is 532 nm.

FIG. 5 is a schematic illustration demonstrating the process for writing nine holograms to combine beams generated at nine separate wavelengths spaced 1 nm apart into a single combined output beam.

FIG. 6 is a schematic illustration of the writing set-up for making an N beam Holographic Beam Combiner by writing N gratings.

FIG. 7 is a schematic illustration of the feedback geometry to be employed in combining lasers.

FIG. 8 is a schematic illustration of a typical cascade stage of a multi-stage transmission Holographic Beam Combiner.

### DETAILED DESCRIPTION OF THE DRAWINGS

The basic idea of the holographic beam combiner (HBC) of the present invention is to write several holograms into a common recording material, with each hologram using a reference beam incident at a different angle, but keeping the object beam at a fixed relative position. When illuminated by a single read beam at an angle matching one of the reference beams, a diffracted beam is produced in the fixed direction of the object beam. When multiple read beams, matching the multiple reference beams are used simultaneously, all the beams can be made to diffract in the same direction, under certain conditions that depend on the degree of mutual coherence between the input beams. Theoretically, both mutually coherent and mutually incoherent beams can be combined, with diffraction effeciencies approaching 100% for each beam individually. In practice, material constraints will reduce the diffraction effeciencies to less than 100%, however with superior fabrication methodologies, effeciencies in excess of 90% have been attained.

For coherent combinations, the input lasers have to be degenerate in frequency. For incoherent combinations, the input lasers are non-degenerate, differing in wavelengths by Δλ, which is dependent on the thickness of the holographic recording medium. The ability to combine large numbers of coherent and incoherent laser beams allows construcing optical power sources made up of numeous low power, low cost semiconductor lasers that find applications in civilian, military and space applications, telecommunications and a wide range of industrial applications.

Solving the obstacles of writing multiple gratings in the same volume is the first step in creating holograms useful for multiple beam combining. The second consideration is to use a light sensitive recording medium that has an inherently high diffraction efficiency, (approaching 100%), is sensitive over a wide range of frequencies, (ideally from about 488 nm to about 2000 nm), is stable over time and is insensitive to envirounmental influences over the temperatures ranges that will be encountered. The maximum index modulation, M#, a paramater that has a typical value of 1 for most permanent thich holograms, will accommodate the writing of one hologram. To write 20 holograms in the same volume of a medium, an M# of 20 or higher is required. Through the selection of the holographic medium, the control of the dye used in the manufacturing process, the mixing and heat treatment of the molded photopolymer material, and the quality control of the impurities that contaminate the material is part of the process for insuring that the photopolymer used for making high channel count beam combiners will result in holograms of the desired quality.

Many photopolymers may be utilized for storing holographic images, and the novel writing and reading techniques described herein will work with other materials. For puropses of illustating this aspect of the invention, the specific photopolymer discussed below is but one example, it being understood that other materials can be used. One such material utilizes quinone-doped polymethyl methacrylate (PMMA) with a material parameter corresponding to the maximum index modulation (M# 20), that has effiencies greater than 90% in each beam. This polymeric material uses a novel principle of “polymer with diffusion amplification”, or PDA. The material can readily withstand power intensities of up to 180 W/sq. cm without a drop in efficency. This is the equivalent to being able to transfer 111 Kw of radiated laser energy utilizing a PMMA delivery geometry with an area of an 8 ½ by 11 inch sheet of paper. The HBC is scalable and the area the size of nine 8 ½ by 11 inch sheets of paper (841.5 sq. inches) will have the ability to transfer 1 Mw of laser power without a drop in effeciency. The energy transfer system is scalable and higher levels of power transer are possible so long as the power intensities of the PDA material are not exceded.

With conventional high index refraction lenses, the beams can be focused to achieve extremely high energy concentrations within an area of a few square centimeters. As the source of the laser power can be multiple small and low cost uncooled diode lasers, the high energy devices that can be built utilizing the HBC technology can also be small and transportable. The breakthrough of being able to build small, uncooled, transportable or portable high energy sources will open many new applications for the HBC technology.

For applications that depend on high stability of the laser sources, such as wave division multiplex (WDM) applications, frequency locking is essential to avoid drifting that contributes to channel instability and loss of diffraction effiency. The present invention utilizes a novel method for locking the frequencies of a plurality of laser beams, through an optical feed back methodology that is ultra stable relative to current art, that creates an individual feedback loops with each laser source through a single optical element.

To reach laser power levels of tens, hundreds, or thousands of watts of power output and higher, large numbers of low cost, low power semiconductor lasers may be used. The most effective means for combining them is to use cascading of two or more stages of combined laser sources and groups of combined laser sources. By starting with an easily managable number of 25 lasers in the first stage for example, feeding into a second stage of say 20 first stage units and a third stage of 20 second stage units, a combined output will the total of 25×20×20 or 10,000 lasers sources, less minor losses contributed by holographic material. If each laser has a power of 50 mw, the resultant output will be 10,000×0.05×0.9×0.9×0.9 or 364.5 W, assuming an efficiency of 0.9 for each cascaded stage

The holograms that are created with the present invention can operate in two directions, so that in WDM applications, both multiplexing and demultiplexing for a given wavelength or family of wavelengths can be accomplished with the same module. The modules can therefore serve as multiplexers or de-multiplexers, depending upon circuit requirements. In a method for writing transmission holograms, a single holographic element may be used to combine and separate laser beams in two directions, offset by 180°.

With the HBC technology, the continuous output power can be controlled by adjusting the number of input laser sources that are contributing to the output at any given time, thus providing a highly accurate, vernier control of output. Control can be accomplished by arranging the powering source to be controlled singly or in groups of the input lasers so that selected combinations can give a continuous adjustment in the output power, over the disired controllable range. Applications such as laser eye surgery or internal artery laser plaque removal that require extremely high stability, accuracy and output control will be satisfied by the HBC technology.

The following description is presented to enable one of ordinary skill in the art to make and use the invention and is provided in the context of a patent application and its requirements. Various modifications to the preferred embodiments will be readily apparent to those skilled in the art and the generic priciples herein may be applied to other embodiments. Thus, the present invention is not intended to be limited to the embodiments shown, but is to be accorded the widest scope consistent with the principles and features described herein.

In order to fully understand the embodiments of this invention, it is first necessary to describe the technique for writing and reading a single holograms onto a holographic substrate and then in writing multiple holograms onto the same substrate, thus creating a holographic beam combiner (HBC). There are two key elements necessary to produce high channel count holographic beam combiners, a) the process for writing and reading a large number of holograms in a given volume of the storage medium, and b) the recording medium used to store the holograms. Though there are many choices for the holographic storage medium and the writing and reading methodolgy will work for any recording material, for illustration purposes, this invention disclosure describes the use of a photo-sensitive polymer, polymethyl methacrylate (PMMA) that has been doped with a small percentage of dye (phenanthraquinone), that results in a process called post-diffusion amplification (PDA), hereinafter referred to as PDA photopolymer. This material has been manufactured to our specifications for the related research and development of this invention, meeting stringent standards for refractive index, bandwidth sensitivity, power density, dye concentration and other parameters that are necessary for reliabily storing multiple holograms in the same volume. The holographic writing and reading process of this invention can be applied to many holographic substrate materials with the results described herein, giving consideration to the variable material related factors that are discussed below.

Reference will now be made in detail to the present preferred embodiments of the invention, examples of which are illustrated in the accompaning drawings, wherein like reference numeral indicate like elements throught the several views.

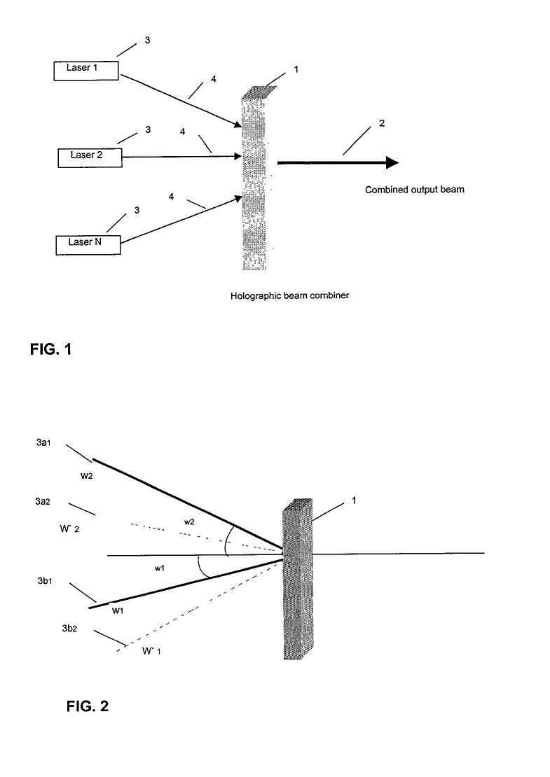

Reference is made to FIG. 1, to describe the basic idea behind the holographic beam combiner. This diagram depicts a plurality of low power laser beams 4 impinging on the HBC 1 at various angles from the left side of the diagram. The Bragg grating formed within the HBC effectively redirects these incident beams so that there is one high power, high brightness, diffraction limited output beam exiting as a single composite beam from the right side of the HBC 1. Briefly, the thick holograms contain numerous gratings, each written by using a reference beam incident at a different angle, while keeping the object beam at a fixed position. When illuminated by a single read beam at an angle matching one of the reference beams, the diffracted beam is produced in the fixed direction of the object beam. When multiple read beams, matching the multiple reference beam, are used simultaneously, all of the beams can be made to diffract in the same direction, under certain conditions that depend on the degree of mutual coherence between the input beams. If the output beam 1 were re-directed back by 180°, the individual beams 4 would exit at the same angles that they entered the HBC.

When the beams are mutually incoherent, it is necessary to ensure that the wavelengths of the neighboring input laser beams differ by an amount greater than the wavelength selectivity bandwidth of each grating (the latter is determined by the read angle and the grating thickness). For mutually coherent beams that are degenerate in frequency, it is necessary to control the relative phases and amplitudes of the input beams in order to produce a single combined beam. In this case, the diffraction efficiency of each individual grating is much less (when combining a large number of beams) than the overall diffraction efficiency, defined as the ratio of the single output beam intensity to the sum of the input intensities. This coherent combining approach is generally quite complicated, thus limiting its practical applications.

In order to ensure that the HBC 1 does not get damaged as the result of the high concentration of the multiple input beams, care must be taken to limit the output power density to below 180 W/cm², for the PMMA material used. This can be done by expanding the beam diameter with conventional optic lenses.

Reference is made to FIG. 2 that is a schematic of a geometry for writing 2 holograms at 532 nm, the specific example values chosen for discussion purposes. It should be noted that other wavelengths can be used, for both writing and reading that can be selected and determined using the equations shown below. The objective is to write an HBC that can combine two lasers that are each at a wavelength near 980 nm. The first step in this process is to choose a set of writing angles for the writing wavelength of 532 mn. A summary of the analysis is:

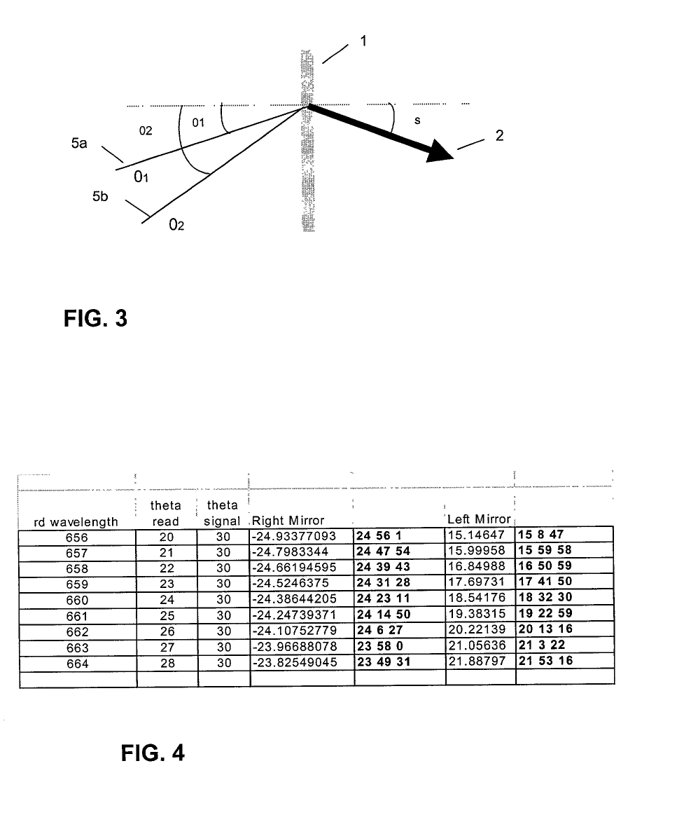

FIG. 2 shows the basic writing geometry. Consider first the process for writing the first hologram; using beams W₁ 3b (reference) and W₂ 3a (object), using laser beams of wavelength 532 nm. We choose these two beams to be symmetric with respect to the axis (perpendicular to the face of the HBC 1) normal to the PDA substrate 1. If read by a laser beam at 532 nm, the read beam will diffract efficiently only if it is Bragg matched, i.e., incident at exactly the same angle as, for example, the object beam (W₂) 3a, and produce a diffracted beam on the other side parallel to the reference beam (W₁) 3b. However, when read by a laser beam O₁ at 980 nm, as shown in FIG. 3, the Bragg incidence angle as well as the diffracted angle (θ_{S}) would be larger. Consider next the process for writing the second hologram, using a new pair of beams at 532 nm: W′₁ 3b and W′₂ 3a, as shown in FIG. 2. The goal is to choose the directions for these two beams to be such that when this hologram is read by a laser beam O₂ (see FIG. 3) at a wavelength of (980 nm+Δλ), where Δλ is to be chosen by the user, the diffracted beam will come out at the same angle θ_{S}.

In designing these angles, the first step is to choose a value of the common diffraction angle, θ_{S}, fix the writing wavelength to be 532 nm, and choose the wavelength for the first read beam, O₁, to be exactly 980 nm (i.e., Δλ₁=O). This determines the first pair of writing angles, θ_{w1} and O_{w2}. We then choose the value of δ, the angular distance between the first and the second read beams (see table of FIG. 4), as well as the wavelength of the second read beam, O₂. These constraints yield a new pair of writing angles, θ′_{w1} and θ′_{w2}, for the beams W′₁ 3b and W′₂ 3a, respectively, in FIG. 2. Explicit analysis shows that these angles are given by:

$$[ {θ}_{W 1} = {Sin}^{- 1} [ {n}_{W} \cdot Sin \{ {Sin}^{- 1} [ \frac{{n}_{R}}{{n}_{W}} \cdot \frac{{λ}_{W}}{{λ}_{R}} \cdot Sin ( {\tilde{θ}}_{S} + \tilde{δ} / 2 ) ] - \tilde{δ} / 2 \} ] ] \\ [ {θ}_{W 2} = {Sin}^{- 1} [ {n}_{W} \cdot Sin \{ {Sin}^{- 1} [ \frac{{n}_{R}}{{n}_{W}} \cdot \frac{{λ}_{W}}{{λ}_{R}} \cdot Sin ( {\tilde{θ}}_{S} + \tilde{δ} / 2 ) ] + \tilde{δ} / 2 \} ] ]$$

where we have defined:

$$[ {\tilde{θ}}_{S} = {Sin}^{- 1} ( \frac{Sin {θ}_{S}}{{n}_{R}} ) ] \\ [ \tilde{δ} = {Sin}^{- 1} ( \frac{Sin ( {θ}_{S} + δ )}{{n}_{R}} ) - {Sin}^{- 1} ( \frac{Sin {θ}_{S}}{{n}_{R}} ) ]$$

wherein δ≡(Re ad Angle at λ_{W})−(Re ad Angle at a predetermined wave length λₒ)

n_{W}≡index at the writing wavelength

n_{R}≡index at the reading wavelength

λ_{W}≡the writing wavelength

λ_{R}≡the reading wavelength

These equations are used as follows:

STEP 1: Choose a fixed value for θ_{S} (e.g., π/3)

STEP 2: Choose a fixed value for λ_{W} (e.g., 532 nm)

STEP 3: Determine the symmetric pair of writing angles, θ_{W1} and θ_{W2}, which correspond to the case of λ_{R}=980 nm, and δ=0

STEP 4: Choose a new value of δ (e.g., 50 mrad) and a new value of λ_{R} (e.g 981 nm), which yield a new pair of writing angles

STEP 5: Repeat step 4 for every new pair of writing angles necessary

In one example, the read angle is at a predetermined wavelength λ_{O}=980 nm although many other wavelengths can be used.

It should be noted that these equations take into account the effect of holographic magnification when the read wavelength is longer than the write wavelength, and the effect of potentially different indices of refraction at the read and write wavelengths.

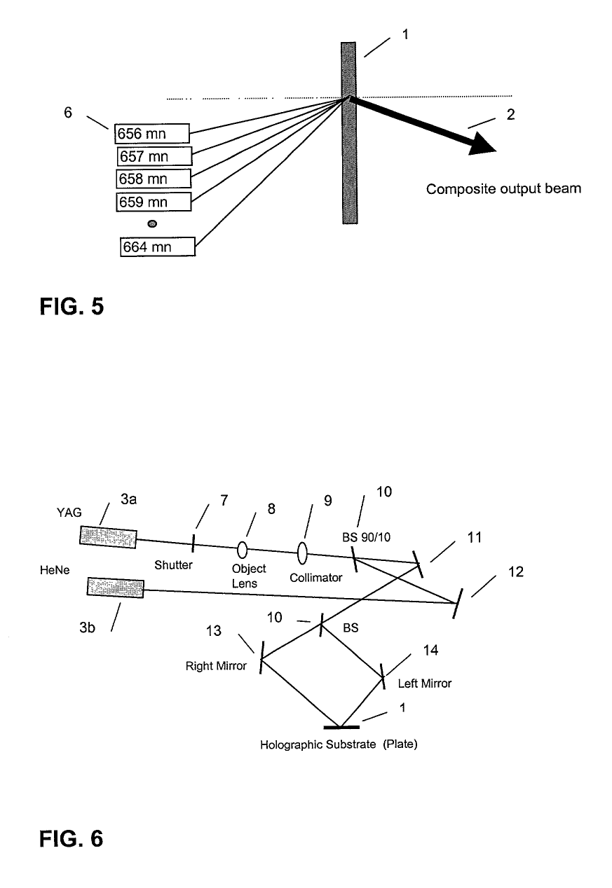

Reference is made to FIG. 5. FIG. 5 is a schematic illustration of a process for writing N holograms, where for purposes of illustration only and not by way of limitation, N=9. The composite output beam 2 exits at the right of the HBC 1 and input beams 6 enter on the left with an incident angle of from 20° to 28°, in increments of 1 nm, The nine orthogonal gratings are to be written in a way so that each one will diffract only one of the input lasers to the fixed output direction. The orthogonality is ensured by the wavelength separation between the neighboring lasers (1 nm⇄≈455 GHz), which is larger than the spectral bandwidth (≈150 GHz) in the transmission geometry shown here, for a sample thickness of 2 mm. The output beams are to emerge at an angle of 30°, superimposed on one another, with a nearly 9 fold increase in brightness. Though this example is for nine beams, the number can be many times higher.

The gratings necessary for this purpose can be written in a single substrate using a Nd:YAG laser at 532 nm with a power of 200 mW. The difference between the read and the write wavelenghts makes it necessary to calculate the writing angles with precision, using a closed form of expression. This calculation also takes into account the differing angles of refraction at the different wavelengths, due to differing indices. Table 1 in FIG. 4 shows these writing angles, corresponding to the writing geometry shown in FIG. 2. The angles are given in decimal degrees, followed by an unmarked column where the values are expressed in degrees, minutes, and seconds.

Reference is made to FIG. 6 that is a schematic illustration of a writing set-up for making N holograms on a holographic substrate 1. With this set-up and using two laser sources 3a, 3b, a plurality of holograms can be written for wavelength that can be either different from each other (incoherent), or the same wavelenghts (coherent). For purposes of explaining the process, a specific set of object and reference wavelengths will be utilized for writing nine holograms (N=9) within the same space, following the analysis developed in the explanation above. Though the specific example uses an N of nine, N can be a large number limited only by the physical characteristics of the holographic media utilized.

An example of the system comprises a Nd:YAG laser 3a operating at 532 nm with a power of 200 mw and a He—Ne laser 3b at 633 nm. Each of the two beams are directed to the holographic plate through a series of mirrors 11,12,13,14 and impinge on the holgographic substrate 1. The He—Ne laser 3b is only for alignment purposes, since the PDA material is insensitive to this wavelength for writing gratings. The beam from the YAG laser 3a is used for writing the holographic gratings. Splitters 10 are used to adjust the outputs to matching levels. A shutter 7 is inserted in the path of the Nd:YAG laser beam 3a to facilitate the alignment during the set-up. The writing process for creating multiple holograms is done by changing the angles of the two mirrors 13, 14 to angles that have been calculated through the process described in connection with the explanation of FIG. 2 above, and exposing the holograpraphic substrate for a period of time that is dependent upon the power of the lasers and the photosensitivity of the holographic material. For the particular set-up desciribe herein, this time ranges from 700 seconds using a 200 mW laser to approximately 70 seconds for a 2 W laser.

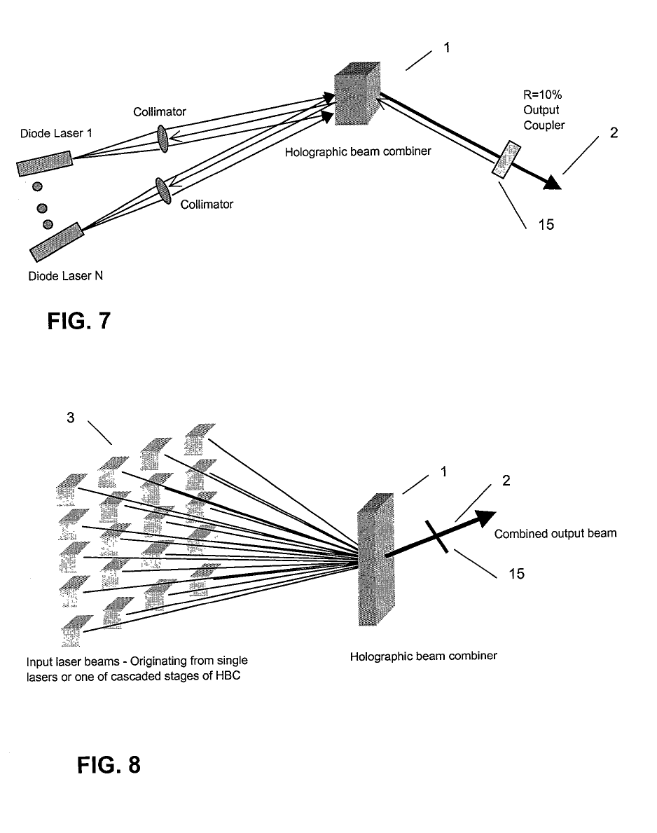

Reference is made to FIG. 7 that is a schematic iillustration of the feedback configuration used in combining lasers. FIG. 7 also shows the readout configuration, demonstrating that any one or any combination of laser beams, when directed to the HBC 1 at the angles established in the writing process of FIG. 2 and calculated in FIG. 4, will exit the HBC at the derived exit angle. Briefly, N holograms would be recorded in a single substrate, using typically a Nd:YAG laser at 532 nm. The angles would be chosen so that during the readout by N non-degenerate lasers (at around 980 nm, for example) the diffracted beams would overlap. Furthermore, during the writing process, only the reference beam will be a plane wave, while the object beam would be diverging (spherical). As such, a divergent read beam (as generated from an uncollimated laser) would diffract into a plane wave.

In general, it is difficult to ensure that the input lasers are each at the desired wavelength. This problem will be eliminated in the presence of the feedback, as illustrated also in FIG. 7. Briefly, the front facet of each laser will be anti-reflective (AR) coated, and the diffracted beams will be reflected back (from 5 to 10%) with a partial reflecting mirror (the output coupler) 15. As such, the lasing cavity for each laser would be formed by its high-reflecting back facet, and the output coupler. Because only a specific frequency (determined by the Bragg conditions) would be diffracted and reflected back efficiencty for a given laser, each laser will automatically tune and lock to the desired frequency.

Reference is made to FIG. 8. FIG. 8 is a schematic illustration of a typical cascade stage of a multi-stage transmission HBC. This configuration depicts typical arrangement where N laser beams 3 can be combined into a HBC 1, with the output 2 directed to a second stage may then be combined further through a multi-stage cascading arrangement. This diagram shows 20 laser sources being combined. In this configuration, the feedback mirror 15 with a 5 to 10% reflection, is inserted into the combined output beam 2, and will lock the individual frequencies of each of the 20 laser sources.

With this background, it can now be shown how low power laser beams can be combined in a cascaded fashion to reach extremely high output power levels. Consider that the lasers that are combined are 1 watt each and there is an efficiency of 90% per cascaded stage. If there are three cascaded staged of 20 combined sources per stage, this would result in (20×1W×0.9)×(20×0.9)×(20×0.9)=5,832 watts. Observing the thermal limits of PMMA of 180 W/cm² (other holographic material that may be used will have a different thermal limit), would require an area of 32.4 sq cm for a final stage of approximately 6 cm by 6 cm to handle this level of laser power. To scale up to hundreds of kilowatts or megawatts would require observing the same thermal limit constraints and designing the output beam density to remain within the acceptable limits. Based on these parameters, one Mwatt of power can be handled by an area of 75 cm by 75 cm.

Thus, summarizing, the key advantage of the approach of this invention is that because of sharp Bragg selectivity of the thick holograms used (several mm), the wavelength separation can be 0.01 nm or less. As such, up to 200 beams can be combined within a bandwidth of 6 nm, using a two stage cascading arrangement. At the achievable levels of 90% efficiency, the combined outputs of these 200 beams will be 180 times greater than the output of the individual laser sources that are combined. With higher numbers of channels per stage and three or more stages, several thousand laser beams can be combined in this manner.

The PMMA material used in the particular embodiment described can readily withstand power intensities of up to 180 W/sq. cm without a drop in efficency. This is the equivalent to being able to transfer 111 Kw of radiated laser energy utilizing a PMMA delivery geometry an area of an 8 ½ by 11 inch sheet of paper. The HBC is scalable and an area the size of just nine 8 ½ by 11 inch sheets of paper (841.5 sq. inches) will have the ability to transfer 1 Mw of laser power without a drop in effeciency. The energy transfer system is scalable and higher levels of power are possible so long as the power intensities of the PDA material are not exceded.

While this invention has been particularly shown and described with references to preferred embodiments thereof, it will be understood by those skilled in the art that various changes in form and details may be made therein without departing from the spirit and scope of the invention as defined by the following claims.

What is claimed is:

1. A method comprising:
directing a plurality of beams of radiation from different angles to a single-aperture, so as to combine the beams and so as to create a single diffraction-limited beam using holographic methodologies such that each of the beams can be subsequently separated from the single diffraction-limited beam.

2. A method according to claim 1, wherein the beams of radiation are mutually coherent.

3. A method according to claim 1, wherein the beams of radiation are mutually incoherent.

4. A method according to claim 1, wherein the beams of radiation are generated at respective wavelengths that are correspondingly spaced no more than 0.01 nm.

5. A method according to claim 1, wherein the combined beam is recorded in a holographic recording material.

6. A method according to claim 5, wherein the beams of radiation are generated at respective wavelengths that are correspondingly spaced no more than 0.01 nm and separately capable of being read using holographic methodologies.

7. An method of writing a hologram to a holographic medium at one wavelength so that it can be selectively read at a different wavelength, wherein the wavelengths are spaced apart over a predetermined range with adjacent wavelengths being separated within 0.01 nm of each other.

8. A method comprising:
generating a plurality of laser beams at multiple frequencies; and
providing a stable, all optic feedback control so as to lock the frequencies of the plurality of laser beams.

9. A method comprising:
cascading two or more stages of laser sources so as to generate laser beams that are combined using holographic methodologies so as to reach at least ten watts of power output.

10. A method comprising:
cascading two or more stages of laser sources so as to generate laser beams that are combined using holographic methodologies so as to reach at least one hundred watts of power output.

11. An improved method comprising:
cascading two or more stages of laser sources so as to generate laser beams that are combined using holographic methodologies so as to reach at least one thousand watts of power output.

12. A method of selectively separating a plurality of combined mutually incoherent laser beams, varying in frequency, from a combined source.

13. A method of writing transmission holograms so that a single holographic substrate may be used to combine and separate laser beams in two directions, offset by 180°.

14. A system comprising:
a plurality of sources of beams of radiation positioned so that the beams of radiation are directed from different angles to the single-aperture so as to combine the beams and so as to create a single diffraction-limited beam using holographic methodologies such that each of the beams can be subsequently separated from the single diffraction-limited beam.

15. A system according to claim 14, wherein the sources of beams of radiation are mutually coherent.

16. A system according to claim 14, wherein the sources beams of radiation are mutually incoherent.

17. A system according to claim 14, wherein the beams of radiation are generated at respective wavelengths that are correspondingly spaced no more than 0.01 nm.

18. A system according to claim 14, further including a holographic medium, wherein the combined beam is recorded in a holographic recording material.

19. A system according to claim 18, wherein the beams of radiation are generated at respective wavelengths that are correspondingly spaced no more than 0.01 nm and separately capable of being read using holographic methodologies.

20. A system for writing a hologram to a holographic medium at one wavelength so that it can be selectively read at a different wavelengths, wherein the wavelengths are spaced apart over a predetermined range with adjacent wavelengths being separated within 0.01 nm of each other.

21. A system comprising:
means for generating a plurality of laser beams at multiple frequencies; and
a stable, all optic feedback control so as to lock the frequencies of the plurality of laser beams.

22. A system comprising:
a plurality of stages of laser sources cascaded together so as to generate laser beams that are combined using holographic methodologies so as to reach at least ten watts of power output.

23. A system comprising:
a plurality of stages of laser sources cascaded together so as to generate laser beams that are combined using holographic methodologies so as to reach at least one hundred watts of power output.

24. A system comprising:
a plurality of stages of laser sources cascaded together so as to generate laser beams that are combined using holographic methodologies so as to reach at least one thousand watts of power output.

25. A system comprising:
a reader for selectively separating a plurality of combined mutually incoherent laser beams previously combined using holographic methodologies and varying in frequency from a combined source.

26. A system for writing transmission holograms so that a single holographic substrate may be used to combine and separate laser beams in two directions, offset by 180°.

27. A method of constructing a plurality of holograms onto a medium, comprising:
creating the plurality of holograms onto the medium using a common object beam and a corresponding plurality of reference beams directed to a single aperture, the reference beams being incident on the single aperture at respective and different angles of incidence while keeping the object beam fixed and the same for all of the reference beams so that when illuminated by a single read beam at an angle matching one of the reference beams, a diffracted beam is produced in the fixed direction of the object beam.

28. A method of reading any one of a plurality of holograms created onto a medium using a common object beam and a corresponding plurality of reference beams directed to a single aperture, the reference beams being incident on the single aperture at respective and different angles of incidence while keeping the object beam fixed and the same for all of the reference beams, comprising:
illuminating the medium with a single read beam at an angle matching one of the reference beams so that a diffracted beam is produced in the fixed direction of the object beam.

29. A method of reading any one of a plurality of holograms created onto a medium using a common object beam and a corresponding plurality of reference beams directed to a single aperture, the reference beams being incident on the single aperture at respective and different angles of incidence while keeping the object beam fixed and the same for all of the reference beams, comprising:
simultaneously illuminating the medium with a plurality of read beams, correspondingly matching the the angles of incidence of at least some of the reference beams, so that a corresponding number of beams can be made to diffract in the same direction.

30. A system for reading any one of a plurality of holograms created onto a medium using a common object beam and a corresponding plurality of reference beams directed to a single aperture, the reference beams being incident on the single aperture at respective and different angles of incidence while keeping the object beam fixed and the same for all of the reference beams, comprising:
a medium;
a source of a single read beam for illuminating the medium at an angle matching one of the reference beams so that a diffracted beam is produced in the fixed direction of the object beam.

31. A system for reading any one of a plurality of holograms created onto a medium using a common object beam and a corresponding plurality of reference beams directed to a single aperture, the reference beams being incident on the single aperture at respective and different angles of incidence while keeping the object beam fixed and the same for all of the reference beams, comprising:
a plurality of sources of reference beams positioned so as to simultaneously illuminate the medium with a plurality of read beams, correspondingly matching the the angles of incidence of at least some of the reference beams, so that a corresponding number of beams can be made to diffract in the same direction.

32. A method of writing a plurality of holograms onto a medium using the following equations:
$$[ {θ}_{W 1} = {Sin}^{- 1} [ {n}_{W} \cdot Sin \{ {Sin}^{- 1} [ \frac{{n}_{R}}{{n}_{W}} \cdot \frac{{λ}_{W}}{{λ}_{R}} \cdot Sin ( {\tilde{θ}}_{S} + \tilde{δ} / 2 ) ] - \tilde{δ} / 2 \} ] ] \\ [ {θ}_{W 2} = {Sin}^{- 1} [ {n}_{W} \cdot Sin \{ {Sin}^{- 1} [ \frac{{n}_{R}}{{n}_{W}} \cdot \frac{{λ}_{W}}{{λ}_{R}} \cdot Sin ( {\tilde{θ}}_{S} + \tilde{δ} / 2 ) ] + \tilde{δ} / 2 \} ] ] \\ [ {\tilde{θ}}_{S} = {Sin}^{- 1} ( \frac{Sin {θ}_{S}}{{n}_{R}} ) ] \\ [ \tilde{δ} = {Sin}^{- 1} ( \frac{Sin ( {θ}_{S} + δ )}{{n}_{R}} ) - {Sin}^{- 1} ( \frac{Sin {θ}_{S}}{{n}_{R}} ) ]$$
wherein δ≡(Re ad Angle at λ_{W})−(Re ad Angle at a predetermined wave length λₒ)
n_{W}≡index at the writing wavelength
n_{R}≡index at the reading wavelength
λ_{W}≡the writing wavelength
λ_{R}≡the reading wavelength comprising the steps of:
a. Choose a fixed value for θ_{S};
b. Choose a fixed value for λ_{W};
c. Determine the symmetric pair of writing angles, θ_{W1} and θ_{W2}, which correspond to the case of λ_{R} and δ=0
d. Choose a new value of δ and a new value of λ_{R}, which yield a new pair of writing angles; and
e. Repeat step d for every new pair of writing angles necessary.
